(19) United States
(12) Patent Application Publication
(10) Pub. No.: US 2025/0386181 A1
(43) Pub. Date: Dec. 18, 2025

(54) METHODS, DEVICES AND SYSTEMS FOR SECURE WIRELESS EXCHANGE OF FEATURE DATA DURING HANDSHAKE PROTOCOL

(71) Applicant: Cypress Semiconductor Corporation, San Jose, CA (US)

(72) Inventor: Hui Luo, Marlboro, NJ (US)

(73) Assignee: Cypress Semiconductor Corporation, San Jose, CA (US)

(21) Appl. No.: 19/083,242

(22) Filed: Mar. 18, 2025

Related U.S. Application Data
(60) Provisional application No. 63/661,009, filed on Jun. 17, 2024.

(51) Int. Cl. H04W 8/22; H04W 12/041; H04W 12/06; H04W 84/12

(52) U.S. Cl. CPC H04W 8/22; H04W 12/041; H04W 12/06; H04W 84/12

(57) ABSTRACT

A method can include, by operation of a first wireless device, generating an internal nonce value having S-bits, generating a code of C-bits by executing at least a first arithmetic-logic (ALU) operation on at least a capability identification value (ID). Substituting bits of the internal nonce value with the code to create a modified nonce value. Wirelessly transmitting the modified nonce in a modified nonce message to a second wireless device. In response to a response message not including capability data corresponding to the code, executing wireless operations according to a first set of capabilities. In response to the response message including capability data, executing wireless operations with capabilities in addition to those of the first set. Corresponding devices and systems are also disclosed.

### CROSS-REFERENCE TO RELATED APPLICATIONS

The present application claims the priority and benefit of U.S. Patent Application No. 63/661,009 filed on Jun. 17, 2024, the contents of which are incorporated by reference herein in their entirety.

### TECHNICAL FIELD

The present disclosure relates generally to wireless systems, and more particularly systems in which two wireless devices exchange an essentially random number, such as a nonce during an exchange.

### BACKGROUND

Wireless protocols (e.g., standards) can include a four-way handshake between an Authenticator and a Supplicant to derive temporal encryption keys. Conventional wireless protocols include the ability to provide a secure exchange of additional information (e.g., an information element, IE) within a four-way handshake.

Referring to FIG. 17, a drawback to exchanging an IE in a conventional four-way handshake is shown in a signaling diagram. A conventional system 1701 can include an Authenticator 1703 and Supplicant 1705, which can execute conventional authentication and association operations 1707-0. Such operations can establish a pairwise master key (PMK). Authenticator 1703 can generate a nonce (ANonce) and Supplicant 1705 can generate a nonce (SNonce). Authenticator 1703 can transmit a first message 1707-0 of the four-way handshake to Supplicant 1705, which can include ANonce in an unencrypted frame (e.g., EAPOL key frame).

Upon receiving first message 1707-1, Supplicant 1705 can generate a pairwise transient key (PTK) using ANonce, SNonce, PMK, its MAC address MAC (Supp), and the Authenticator's MAC address MAC (Auth). Supplicant 1705 can prepare and transmit a second message 1707-2 of the four-way handshake to Authenticator 1703. A second message 1707-2 can include SNonce, a Robust Secure Networking Element (RSNE) or a Robust Secure Networking Element extra (RSNEX) and a corresponding message integrity code (MIC). If the Supplicant 1705 supports the exchange of a secure IE, it can set a bit in the RSNE or a RSNEX field indicating such a capability.

Upon receiving second message 1707-2, Authenticator 1703 can validate the message using the included MIC. Authenticator 1703 can generate its own PTK in the same manner as Supplicant 1705 using the received SNonce. In addition, Authenticator 1703 can detect a bit set in a RSNE or RSNEX field, and determine which type of IE is supported. Authenticator 1703 can then transmit the third message 1707-3 of the four-way handshake to Supplicant 1705. The third message 1707-3 can include ANonce, RSNE or RSNEX, the supported IE and a corresponding MIC. Authenticator 1703 may also include an encrypted groupwise transient key (GTK).

Upon receiving the third message 1707-3, Supplicant 1705 can attempt to validate the received MIC by calculating its own MIC. However, there are conventional Supplicants that can incorrectly interpret RSNE, RSNEX or the included IE. For example, a MIC validation can fail 1705-1. As a result, a four-way handshake can terminate 1709 prematurely. However, if RSNE/RSNEX is not included in a message 2 protected by a MIC and/or RSNE/RSNEX and IE are not included in a message 3, the exchange can be subject to a man-in-the-middle attack which can alter a transmitted IE or insert its own IE.

To address the above drawbacks, the inclusion of unprotected IEs is proposed, including a RSNE Override (RSNO), RSNE Override 2 (RSNO2) or RSNEX Override (RSNOX) IE. However, such proposed new IEs are subject to their own man-in-the-middle attack. A rogue Authenticator (e.g., AP) can impersonate compatibility (e.g., WPA3 compatibility mode) and not include the new IEs, misleading an RSNO aware Supplicant (e.g., STA) to connect to it using an alternate protocol, such as WPA2, for a WPA3-to-WPA2 downgrade attack.

It would be desirable to arrive at some way of providing for the secure exchange of additional capability data (e.g., IE) in a four-way exchange that does not suffer from conventional drawbacks.

### SUMMARY

A method can include, by operation of a first wireless device, generating an internal nonce value having S-bits, generating a code of C-bits by executing at least a first arithmetic-logic (ALU) operation on at least a capability identification value (ID). Substituting bits of the internal nonce value with the code to create a modified nonce value. Wirelessly transmitting the modified nonce to a second wireless device. In response to receiving a response message that does not include capability data corresponding to the code, wireless operations can be executed according to a first set (e.g., baseline) capabilities. In response to receiving a response message that includes capability data corresponding to the secret code, wireless operations can be executed with capabilities in addition to those of the first set. Corresponding devices and systems are also disclosed.

### BRIEF DESCRIPTION OF DRAWINGS

FIG. 1 is a signaling diagram showing a system and operations according to an embodiment.

FIG. 2 is a signaling diagram showing a system and operations according to another embodiment.

FIG. 3 is a signaling diagram showing a system and operations according to a further embodiment.

FIGS. 4-0, 4-1 and 4-2 are diagrams showing a nonce, a modified nonce, and decoding of a modified nonce according to embodiments.

FIG. 5 is a block diagram of a wireless device according to an embodiment.

FIG. 6 is a block diagram of a wireless device according to another embodiment.

FIG. 7 is a block diagram of a Supplicant wireless device according to an embodiment.

FIG. 8 is a diagram of an Authenticator wireless device according to an embodiment.

FIG. 9 is a flow diagram of a method according to an embodiment.

FIG. 10 is a flow diagram of a method according to another embodiment.

FIG. 11 is a flow diagram of a method executable by a Supplicant according to an embodiment.

FIG. 12 is a flow diagram of a method executable by an Authenticator according to an embodiment.

FIG. 13 is a block diagram of an integrated circuit device according to an embodiment.

FIG. 14 is a diagram of an automobile system according to an embodiment.

FIG. 15 is a diagram of an Internet-of-Things type system according to an embodiment.

FIG. 16 is a diagram showing capabilities of wireless devices according to embodiments.

FIG. 17 is a signaling diagram showing a conventional system and operations.

### DETAILED DESCRIPTION

According to embodiments, a first wireless device can operate according to a protocol in which a nonce, or similar value, is expected to be transmitted to a second wireless device. A nonce can be generated, and selected bits of the nonce can be substituted with a code to create a modified nonce. The code can carry information identifying additional capabilities of the first wireless device. Upon receiving a modified nonce, a second wireless device can execute predetermined arithmetic logic (ALU) operations on the modified nonce to determine the additional capabilities. Data corresponding to such additional capabilities can then be transmitted to the first wireless device in a response message.

In some embodiments, transmission of the modified nonce can be a second message in a four-way handshake. In some embodiments, such a four-way handshake can be between a Supplicant and Authenticator in a protocol compatible with one or more IEEE 802.11 wireless standards. A modified nonce can be an supplicant nonce (SNonce) provided to an Authenticator.

In some embodiments, a modified nonce can be created by generating a nonce, truncating the nonce, and then appending a code to the truncated nonce. A resulting modified nonce can be transmitted unencrypted in a message that also includes an message integrity code (MIC) for validating the message contents.

In some embodiments, a first wireless device can receive an external nonce from a second wireless device. A code can be generated with one or more ALU Ops that includes a portion of the external nonce and capability data.

In some embodiments, a modified nonce can be used by both a first and second wireless device in the derivation of a mutual encryption key. In some embodiments, an Authenticator and Supplicant can execute initial authentication and association operations according to one or more IEEE 802.11 wireless standards to arrive at a pairwise mutual key (PMK). A modified nonce (along with other values) can be used by both Authenticator and Supplicant to derive a pairwise transient key (PTK) for encrypted transmissions between the two devices.

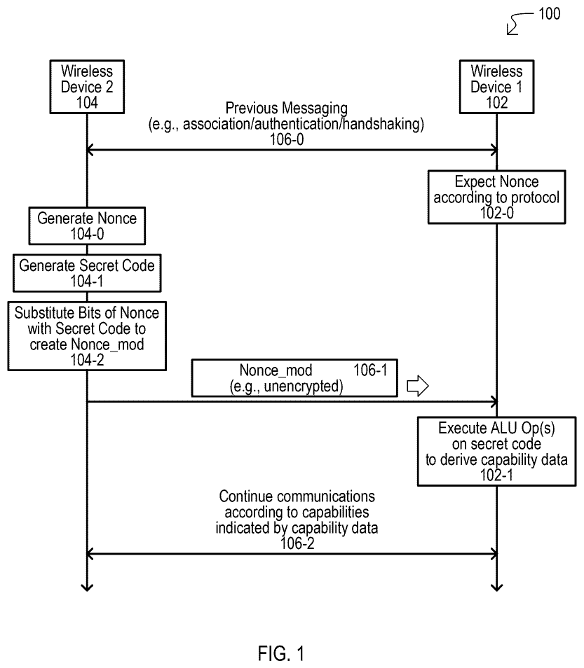

FIG. 1 is a signaling diagram showing a system 100 and corresponding operations according to an embodiment. A system 100 can include a first wireless device 102 and a second wireless device 104. Wireless devices (102 and 104) can communicate with one another with wireless messaging 106-0 according to one or more wireless protocols (e.g., standards). According to such a protocol, a first wireless device 102 can be expecting the receipt of a nonce 102-0, or similar value, from a second wireless device 104. A nonce or similar value can be a value that is not expected to repeat itself during most of, if not the entire lifetime of a device. In some embodiments, a nonce can be a cryptographic nonce that is also randomly or pseudo-randomly generated.

According to the established protocol, a second wireless device 104 can generate a nonce 104-0. Such a nonce can be generated according to a predetermined algorithm established by the protocol. Second wireless device 104 can also generate a secret code 104-1. A secret code can be a value having fewer bits than a generated nonce. Further, a secret code can convey capability information related to wireless operations of second wireless device 104. A secret code can be considered “secret” as its contents can be hidden by one or more arithmetic-logic operations (ALU Ops) prior to being transmitted. It is understood that first wireless device 102 can be capable of deriving the code (e.g., capability data) information by executing its own ALU operation(s) on the received secret code. Second wireless device 104 can substitute bits of the generated nonce with bits of the secret code to create a modified nonce (Nonce_mod) 104-2. Nonce_mod can be transmitted to first wireless device 106-1. In some embodiments, such a transmission can include Nonce_mod being transmitted in unencrypted form.

Upon receiving Nonce_mod, first wireless device 102 can execute one or more ALU Ops on the secret code to derive capability data 102-1. Such an action can include executing ALU Ops on all or a portion of Nonce_mod that includes the secret code. Having determined capability data, first wireless device 102 can continue communications with second wireless device 104 according to the capabilities indicated by the capability data 106-2. Such additional capabilities can include any capabilities related to operations of the device(s), such as security related features as but one of many examples.

In this way, one wireless device can transmit a nonce value expected by another wireless device, where the nonce can include a secret code, decodable by the other device, that can indicate additional capabilities of the one wireless device.

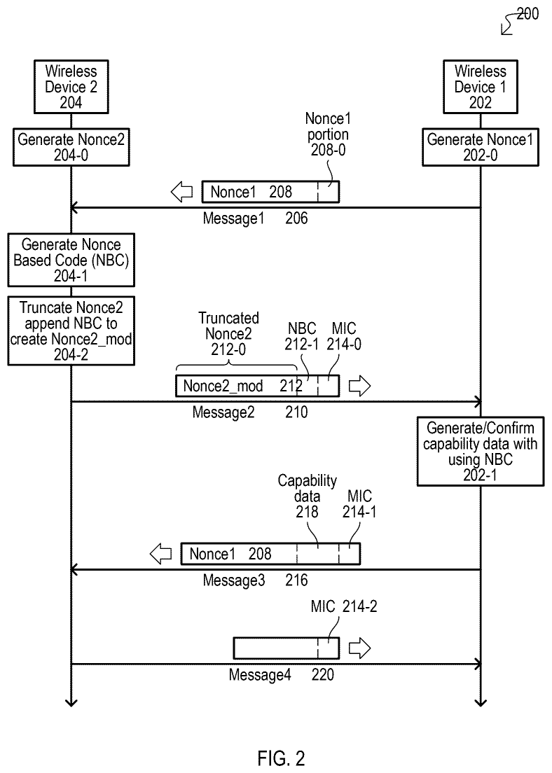

FIG. 2 is a signaling diagram showing a system 200 and corresponding operations according to another embodiment. In some embodiments, a system 200 can be one implementation of that shown in FIG. 1. A system 200 can include a first wireless device 202 and second a wireless device 204, and can show a four-way (4-way) handshake. A 4-way handshake can include a transmission of four messages back and forth between first and second devices 202 and 204. A first wireless device 202 can generate a first nonce (Nonce1) 204-0, a second wireless device 204 can generate a second nonce (Nonce2) 202-0.

A first wireless device 202 can transmit a first message (Message1) 206 to a second wireless device 204. Message1 206 can include Nonce1 208. Nonce1 can include a nonce portion 208-0. A nonce portion 208-0 can be subset of the total bits of Nonce1. In some embodiments, a nonce portion 208-0 can be a contiguous. In some embodiments, a Nonce 1 208 can be transmitted in an unencrypted state.

In response to receiving Message1 206, a second wireless device 204 can generate a nonce based code (NBC) 204-1. A NBC can be a code generated by one or more ALU Ops, using a code value, and a portion of a nonce generated by first wireless device 202 and/or second wireless device 204. In an embodiment, NBC 204-1 can be generated by one or more ALU ops on Nonce1 portion 208-0 and a capability code that identifies additional capabilities supported by second wireless device 204. Nonce2 can be truncated, and an NBC can be appended to the remainder of Nonce 2, to generate a modified Nonce2 (Nonce2_mod) 204-2.

Second wireless device can transmit a second message (Message2) 210 to second wireless device 204 that can include Nonce2_mod, having a truncated Nonce2 212-0 and NBC 212-1. Message2 210 can also include a validation code 214-0, by which a first wireless device 202 can confirm the contents of Message2 210. In some embodiments, a validation code can be a message integrity code (MIC). A MIC can be generated with a cryptographic operation on some or all of the other contents of Message2 210.

In response to receiving Message2 210, a first wireless device 202 can generate and/or confirm capability data using NBC 212-1 included within Nonce_2 of Message2 210. Capability data can include any suitable data, including that which describes to a first wireless device 202 capabilities of second wireless device 204 that may go beyond a current protocol, or are included in a current protocol but are not mandatory. In some embodiments, additional capability data can be related to a vendor or group of vendors. Such additional capabilities may not be utilized in communications between first and second wireless devices (202 and 204) absent transmission of a NBC and successful decoding of the NBC by a second wireless device.

First wireless device 202 can transmit a third message (Message3) to second wireless device 204. Message3 216 can include Nonce1, capability data 218 indicated by the NBC, and a validation code 214-1. Capability data 218 can be used by first wireless device 202, second wireless device 204 or both to perform additional capabilities. A validation code 214-1 can be MIC.

In response to Message3, a second wireless device 204 can transmit a fourth message (Message4) 220. Message4 220 can conclude a 4-way handshake. In some embodiments, a Message4 220 can include data related to additional capabilities.

In this way, wireless devices in communication with one another device can generate nonces and execute a 4-way handshake. A first message can carry a first nonce. A second message can carry a modified second nonce with a code that can indicate additional capabilities. A third message can include additional capability data, determined by decoding the code. A fourth message can conclude the 4-way handshake.

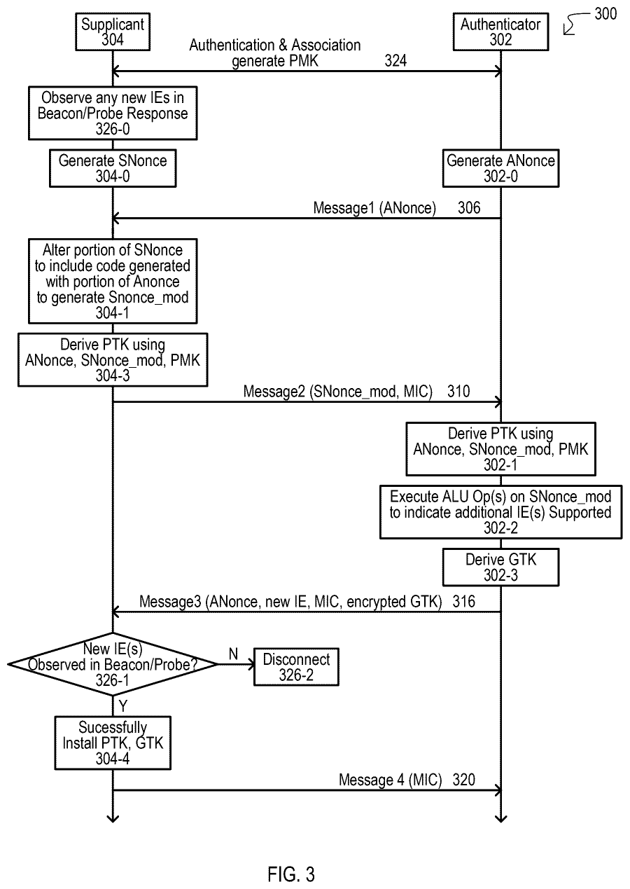

FIG. 3 is a signaling diagram showing a system 300 and corresponding operations according to another embodiment. In some embodiments, a system 300 can be one implementation of that shown in FIG. 1. A system 300 can include a wireless device operating as an Authenticator 302 and a wireless device operating as a Supplicant 304. An Authenticator 302 can control access to a network based on information provided by a Supplicant 304. An Authenticator 302 and Supplicant 304 can execute a 4-way handshake according to one or more IEEE 802.11 wireless standards.

In the embodiment shown, Authenticator and Supplicant (302 and 304) can execute an authentication and association operation 324. Such operations can be according to one or more IEEE 802.11 wireless standards. From such operations, Authenticator and Supplicant (302 and 304) can arrive at a mutual encryption key, such as a pairwise master key (PMK), as but one example. In addition, a Supplicant 304 can observe the presence of one or more new IEs occurring in a communication with Authenticator 326-0, such as a beacon or probe as but two examples.

An Authenticator 302 can generate a nonce (ANonce) 302-0 and a Supplicant can generate a nonce (SNonce) 302-1. Authenticator 302 can transmit a Message1 306 addressed to Supplicant 302 that includes ANonce. In some embodiments, such a message can be unencrypted. In some embodiments, Message1 306 can be compatible with an Extensible Authentication Protocol over LAN (EAPOL), taking the form of an EAPOL key message.

Upon receiving Message1 306, Supplicant 304 can alter a portion of SNonce to include a code to generate a modified SNonce (SNonce_mod) 304-1. In an embodiment, such an action can use a portion of ANonce. In an embodiment, Supplicant 304 can execute one or more ALU Ops on a portion of ANonce and a capability identification code (ID) to generate a secret code. Bits of the secret code can be substituted for bits of SNonce to form SNonce_mod. In one embodiment, Supplicant 304 can execute one or more ALU Ops between a last m+6 octets of ANonce and m+6 octets of a code. Six octets of m+6 octets can be a capability ID, and “m” octets of the m+6 octets can be a predetermined pattern that an indicate or confirm a capability ID. A resulting secret code, which can be of m+6 octets, can be substituted for the last m+6 octets of SNonce to create SNonce_mod. In an embodiment, a Supplicant can execute an XOR operation between a portion of ANonce and a same sized code that includes a capability ID to create a secret code. In an embodiment, a capability ID can indicate additional information elements (IEs) supported by a Supplicant 304.

Supplicant 304 can generate a mutual temporary key using at least the PMK, ANonce and SNonce_mod 304-3. In an embodiment, such a key can be a pairwise temporal key (PTK) generated by a cryptographic function using PMK, ANonce, SNonce, a MAC address of Authenticator 302 and a MAC address of Supplicant 304.

Supplicant 304 can then transmit a Message2 addressed to Authenticator 302 that can include SNonce_mod and a MIC 310. SNonce_mod can be unencrypted within Message2. In an embodiment, Message2 can be an EAPOL key message.

Upon receiving Message2 310, Authenticator 302 can derive a same mutual temporary key as Supplicant 302 using at least the PMK, ANonce and SNonce_mod 302-1. In an embodiment, such a key can be the PTK as described for Supplicant.

Authenticator 302 can also execute one or more ALU Ops on SNonce_mod to indicate IEs supported by Supplicant 302-2. Such an action can derive a code ID from a secret code included with SNonce_mod. In one embodiment, Authenticator 302 can execute an XOR operation between bits at locations corresponding to a secret code and corresponding bit locations of ANonce. However, such a particular decoding method should not be construed as limiting. Authenticator 302 can also derive a key intended for use in multi-cast transmissions 302-3. In the embodiment shown, such a key can be a group temporal key (GTK).

Authenticator 302 can transmit a Message3 316 addressed to Supplicant 304 that includes ANonce, new IE(s) indicated by decoding a portion of SNonce_mod, a MIC, and a GTK. In some embodiments, ANonce and new IE(s) can be unencrypted, however, GTK can be encrypted. In some embodiments, Message3 306 can be an EAPOL key message.

Upon receiving Message3 316, a Supplicant 304 can determine if new IE(s) included in Message3 were observed in a previous communication from Authenticator 326-1. If such IE(s) were not previously observed (N from 326-1), a Supplicant 304 can disconnect from an Authenticator 326-2. If such IE(s) were previously observed (Y from 326-1), after successfully installing temporary key(s) (e.g., PMK, and optionally GTK) 304-4, a Supplicant 304 can transmit a Message4 320 addressed to Authenticator 302. In some embodiments, a Message4 320 can include bit values indicating a state of Supplicant 302 (e.g., installation of keys successful).

Supplicant 302 and Applicant 304 can then continue operations based on capabilities indicated by the IE(s).

In this way, in a 4-way handshake that exchanges nonces to establish temporary encryption keys, a Supplicant can return to a nonce to an Authenticator that includes a secret code that indicates the Supplicant's compatibility with IEs beyond those provided by a basic protocol.

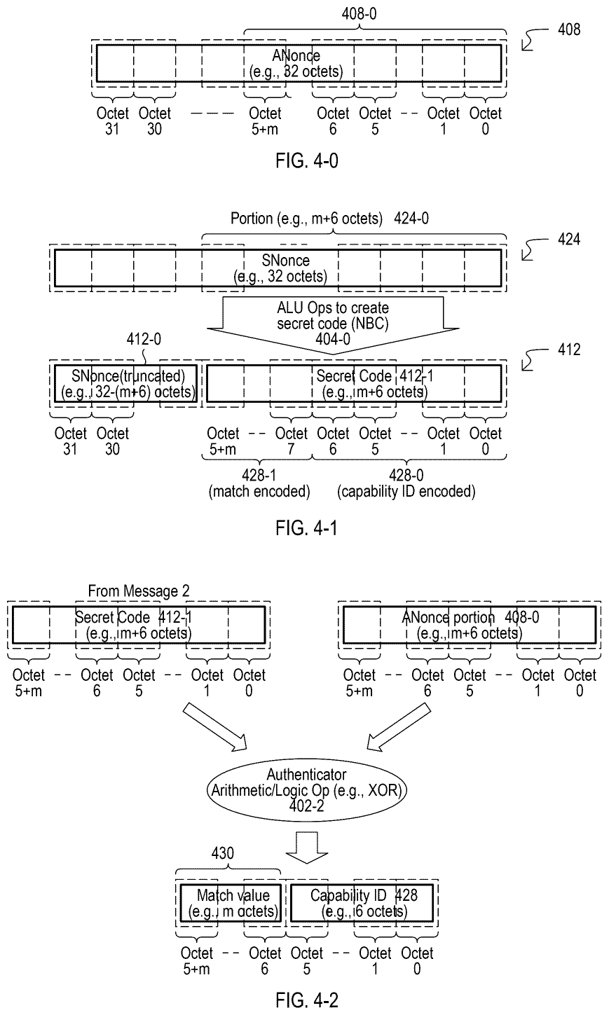

FIG. 4-0 shows a first nonce 408. In an embodiment, a first nonce 408 can be an ANonce received by a Supplicant from an Authenticator. A first nonce 408 can be transmitted to another device (e.g., Supplicant), and can include a compare portion 408-0. In some embodiments, a compare portion 408-0 can be used by the device generating the nonce (e.g., Authenticator) to decode a secret code. In the embodiment shown, a first nonce 408 can include 32 octets (Octet 0 to Octet 31). A compare portion 408-0 can include m+6 octets. A nonce 408 can be a cryptographic nonce generated according to any suitable fashion, including but not limited to, with a random and/or pseudo-random number (prand) and timestamp, and/or with a sufficiently large prand that repetition is improbable given the use case.

FIG. 4-1 shows operations for generating a modified nonce 412 according to an embodiment. In embodiments, a modified nonce 412 can be a modified SNonce (SNonce_mod) transmitted from a Supplicant to an Authenticator. Such operations can begin with an initial nonce 424. In some embodiments, an initial nonce 424 can be generated according to a protocol that uses such a nonce to derive cryptographic keys. An initial nonce 424 can be suitable for a protocol, but can include a modifiable portion 424-0 that can be changed to include capability information (e.g., IEs). In an embodiment, an initial nonce 424 can be a SNonce generated by a Supplicant that provides encryption data to an Authenticator.

Referring still to FIG. 4-1, a modifiable portion 424-0 can be substituted with a secret code 412-1 created by one or more ALU Ops 404-0. In the embodiment shown, a secret code 412-1 can include an encoded capability ID 428-0 as well as an encoded matching value 428-1. When an encoded capability ID 428-0 is decoded, it can identify additional features supported by a device, such as those identified by, or that make use of, “new” IEs. A new IE can be an IE, that in a default execution of a protocol, is not used or expected. However, when support for the new IE is indicated, communications can proceed with messages that include the IE and/or additional capabilities indicated by the new IE. When an encoded matching value 428-1 is decoded, it can reveal a predetermined pattern that can validate a corresponding capability ID 428-0. Such a matching value can take any suitable form that can be recognized or understood by a device (e.g., Authenticator) that decodes the secret code 412-1. In the embodiment shown, an encoded capability ID 428-0 can be six octets and an encoded match value 428-1 can be “m” octets, where m is an integer greater than zero.

FIG. 4-2 shows a decoding operation for decoding a secret code included in a modified nonce. A decoding operation 402-2 can include executing one or more ALU Ops on a secret code 412-1 and a portion of a previously transmitted nonce 408-0. In embodiments, such operations can be performed by an Authenticator using a portion of an SNonce_mod after received from a Supplicant, and using a portion of a previously transmitted ANonce. In the embodiment shown, a secret code 412-1 can be m+6 octets and the nonce portion 408-0 can be m+6 octets.

In a particular embodiment, decoding operations 402-2 can include a logical XOR between a secret code 412-1 and a portion of the previously transmitted nonce 408-0. Decoding operations 402-2 can produce a capability ID 428 and match value 430. A capability ID 430 can identify capabilities of a device transmitting the secret code, an in some embodiments can identify new IE(s) that are supported, as described herein or equivalents. If a match value 430 does not match an expected match value, the decoding results can be considered invalid. In the embodiment shown, a capability ID can be 6 octets and a match value can be m octets.

In this way, consecutive portions of a nonce for transmission can be transformed into a secret code using a received nonce. The secret code can include a capability ID and match value. A capability ID can indicate capabilities of a device. A match value can validate the capability ID when the secret code is decoded.

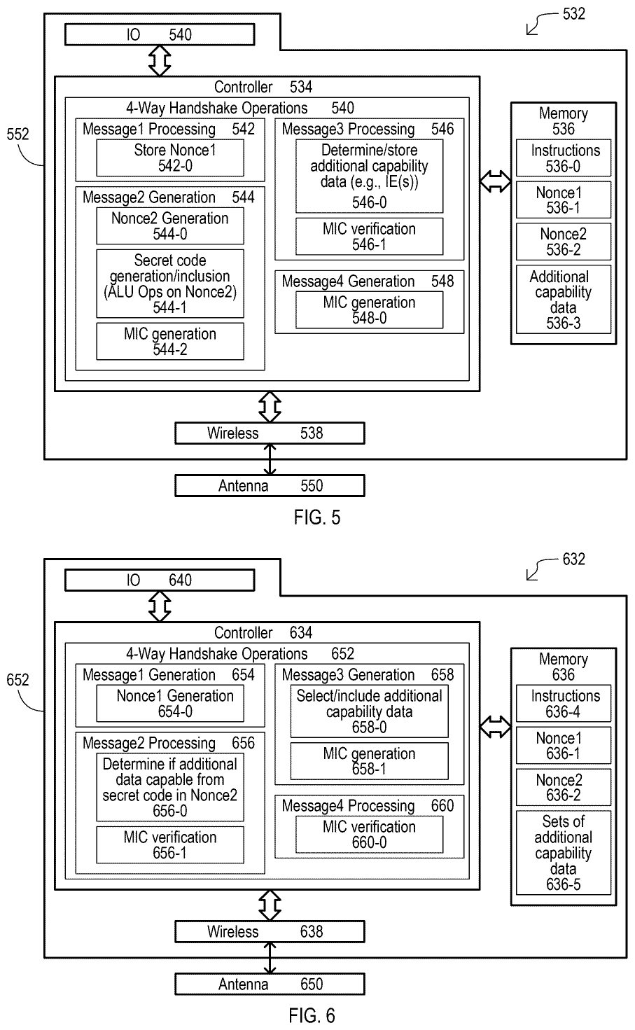

FIG. 5 is a block diagram of a device 532 according to an embodiment. In some embodiments, a device 532 can be a second wireless device, or Supplicant as described for embodiments herein. A device 532 can include controller circuits 534, memory circuits 536, wireless circuits 538, and input/output (IO) circuits 540. Operations provided by controller circuits 544 can include, but are not limited to, 4-way handshake operations 540, related to an exchange of four messages in the order: Message1, Message2, Message3 and Message4. Message1 and Message3 can be received from another wireless device, Message2 and Message4 can be transmitted by device 532. Message1 processing 542-0 can include storing a Nonce1 542-0 that can be included in a Message1 received from another device.

Message2 generation 544 can include generating values for inclusion in Message2 transmitted to another device. A Nonce2 can be generated 544-0. A secret code can be generated and included in a Nonce2 (e.g., to create a modified Nonce2) 544-1. Such operations can include any of those described herein, or equivalents, including but not limited to a secret code that includes a capability ID. In the embodiment shown, MIC generation 544-2 can generate a MIC for transmission with Message2 that can validate the contents of Message2, including a modified Nonce2. Contents of Message2 can be transmitted without encryption. Accordingly, a Message2 transmitted by device 532 can include a Nonce2 with a secret code as well as a MIC.

Message3 processing 546 can include determining and storing additional capability data that can be received in a Message3 546-0. Such an action can include confirming the presence of additional capability data corresponding to a secret code included in the previous Message2. In the embodiment shown, a MIC verification 546-1 can be included, which can serve to validate the contents of Message3, including additional capability data, which may be transmitted without encryption.

Message4 generation 544 can include generating values concluding a 4-way handshake, including confirming that values for continuing a connection have been exchanged/generated successfully. In the embodiment shown, MIC generation 548-0 can be included. Accordingly, a Message4 transmitted by device 532 can include a confirmation data as well as a MIC.

Controller circuits 534 can include any circuits suitable for executing operations related to a 4-way handshake described herein, including but not limited to, one or more processing circuits, including instructions, custom logic, programmable logic, and combinations thereof. Control circuits 534 can include a state machine, a sequencer and/or some other type of control circuit, which may be implemented in the form of hardware, firmware, or software, or combinations thereof.

Memory circuits 536 can store data related to the various operations of device 534, including but not limited to instructions 536-0 executable by controller circuits 534, a Nonce1 536-1 received in a Message1, a Nonce2 536-2 transmitted in a Message2, that can include a secret code, and additional capability data 536-3 received in a Message3. Memory circuits 536 can include any suitable memory circuits, including nonvolatile memory, volatile memory or combinations thereof.

Wireless circuits 538 can include circuits for receiving a Message1 and Message3, and for transmitting a Message2 and Message 4. Wireless circuits 538 can include circuits compatible with one or more standards, including public and/or private standards. IO circuits 540 can input or output signals that can enable control of a device 532 from sources external to the device according to any suitable fashion. In some embodiments, IO circuits 540 can include serial communication circuits, including but not limited to interfaces compatible with a serial digital interface (SDI), universal serial bus (USB), universal asynchronous receiver transmitter (UART), 12C, or 12S. In the embodiment shown, a device 532 can include an antenna system 550 connected to wireless circuits 538.

In some embodiments, IO circuits 540, controller circuits 534, memory circuits 538 and wireless circuits 538 can be formed with a same integrated circuit substrate 552.

In this way, a wireless device can include circuits for executing a 4-way handshake operation in which a transmitted second message can include a nonce value modified to include a secret code that identifies additional capabilities.

FIG. 6 is a block diagram of a device 632 according to another embodiment. In some embodiments, a device 632 can be a first wireless device, or Authenticator as described for embodiments herein. A device 632 can include items like those of FIG. 5, and such like items are referred to by the same reference character but with the leading digit being a “6” instead of “5”.

Controller circuits 634 can execute 4-way handshake operations 640, which can correspond to those shown in FIG. 5. Operations executed by controller circuits 634 can include Message1 generation 642-0, which can generate a Nonce1. Accordingly, a Message1 transmitted by device 632 can include a Nonce1.

Message2 processing 656 can include determining if a device has additional capabilities from a secret code in a Nonce2 656-0. Such an action can include performing one or more ALU Ops on a portion of Nonce2 as described herein or equivalents. In the embodiment shown, MIC verification 656-1 can be included. This can enable device 632 to validate Message2, including a Nonce2 with a secret code.

Message3 generation 658 can include selecting and including additional capability data into a Message3 658-0. Such an operation can occur if a secret code in a received Message2 is successfully decoded (and validated if a MIC is included). A decoded secret code can indicate which additional capability data can be included in a Message3. In the embodiments shown, MIC generation 658-1 can be included. Accordingly, a Message3 transmitted by device 632 can include additional capability data as well as a MIC.

Message4 processing 660 can include MIC verification 660-0. Device 632 can validate whether a 4-way handshake has been successful, based on data and a MIC included in a received Message4.

Memory circuits 636 can store data related to the various operations of device 632, including but not limited to instructions 636-4 executable by controller circuits 634, a Nonce1 636-1 transmitted in a Message1, a Nonce2 636-2 received in a Message2 (that can include a secret code), and sets of additional capability data 636-5. Based on one or more capabilities determined by a secret code in Message2, a device 632 can select from multiple possible capability data for inclusion in a Message3.

In this way, a wireless device can execute a 4-way handshake operation in which a received second message can be decoded to determine additional capabilities of another device. A subsequent third message can include data related to such additional capability data.

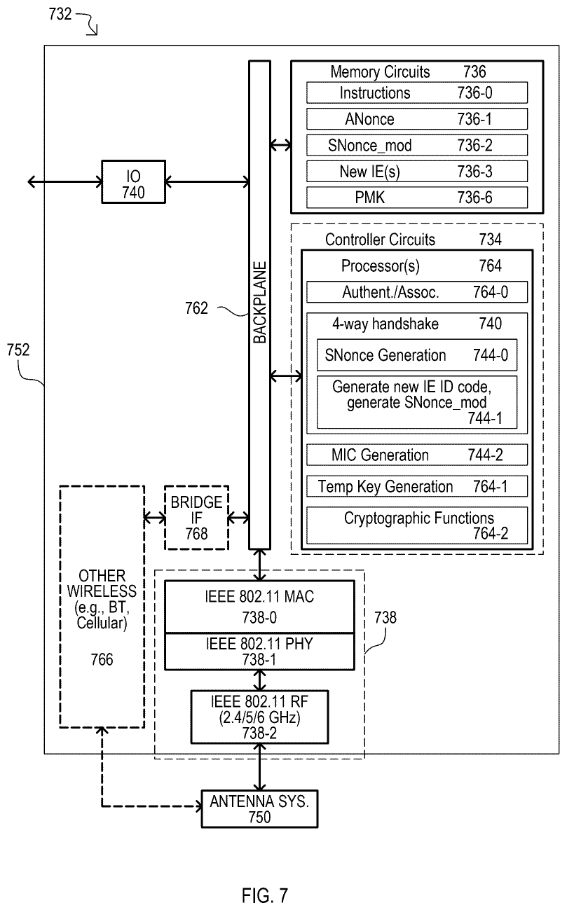

FIG. 7 is a block diagram of a wireless device 732 according to another embodiment. In some embodiments, a wireless device 732 can be a Supplicant and one implementation of that shown in FIG. 5. A wireless device 732 can include items like those of FIG. 5, and such like items are referred to by the same reference characters but with the leading digit being a “7” instead of “5”.

A wireless device 732 can include memory circuits 736, controller circuits 734, wireless circuits 738, and IO circuits 740. Optionally, a wireless device 732 can include other wireless circuits 766 and bridge interface (IF) circuits 768. Such sections can be connected to one another over a backplane/bus 762. Memory circuits 736 can include any suitable memory circuits as described herein and equivalents. Memory circuits 736 can store instructions 736-0 used by controller circuits 734. In some embodiments, instructions 736-0 can include code (e.g., firmware) executable by processor circuits 764 to provide the various processor operations described herein. Memory circuits 736 can also store data used in, or generated by, operations of wireless device 732. Such data can include, but not limited to, a received ANonce 736-1, SNonce_mod 736-2 generated by the wireless device 732, one or more new IE(s) 736-3 received from another wireless device, and master key 736-3 established during authentication/association operations. In an embodiment, master key can be a PMK compatible with one or more IEEE 802.11 wireless standards.

Controller circuits 764 can include processor circuits 764. Processor circuits 764 can execute instructions 736-0 to provide various functions for the wireless device 732. Operations provided by processor circuits 764 can include, but are not limited to, authentication and/or association 764-0, 4-way handshake operations 740, MIC generation 744-2, temporary key generation 764-1 and cryptographic functions 764-2. Authentication/association 764-0 can include authentication operations that can establish an identity of another wireless device (and enable the other wireless device to establish its identity), as well as establish initial encryption key values. Association operations can enable a wireless device 732 to establish itself in a wireless network (e.g., register with device controlling a network, or directly with another device in a peer-to-peer configuration). In some embodiments, authentication/association 764-0 can result in a wireless device 732 determining additional capabilities (e.g., new IEs) supported by the other wireless device. In some embodiments, authentication/association operations 764-0 can be compatible with one or more IEEE 802.11 wireless standards.

4-way handshake operations 740 can include executing a 4-way handshake operation with another wireless device as described herein and equivalents. Such operations can include generation of SNonce 744-0 and generation of new IE ID code and SNonce_mod generation 744-1. Operations 744-0 can generate a Supplicant nonce according to a predetermined protocol. However, such an SNonce is not transmitted in its initial form to an Authenticator. Operations 744-1 can include generating a new IE ID code that identifies additional capabilities supported by a wireless device 732. In addition, an SNonce_mod can be generated by substituting a portion of SNonce with the new IE ID code. In some embodiments, 4-way handshake operations 740 can include the receipt of an ANonce value in a Message1, transmission of SNonce_mod in a Message2, and receipt of one or more new IEs in a Message3. In some embodiments, 4-way handshake operations 740 can be compatible with one or more IEEE 802.11 wireless standards.

MIC generation 744-2 can generate MICs for transmitted messages from wireless device 732. In an embodiment, MIC generation 744-2 can generate MICs for a Message2 and Message4 of a 4-way handshake operation 740.

Temporary key generation 764-1 can generate temporary key values used in message encryption. In an embodiment, temporary key generation 764-1 can generate keys based on a received ANonce and SNonce_mod. In an embodiment, temporary key generation 764-1 can generate a PTK compatible with one or more IEEE 802.11 wireless standards, using PMK 736-6, ANonce 736-1, SNonce_mod 736-2.

Cryptographic functions 764-2 and encrypt messages for transmission and decrypt received messages. In some embodiments, SNonce_mod can be transmitted unencrypted in 4-way handshake operations 740. However, once a SNonce_mod has been generated and temporary key(s) generated 764-1, cryptographic functions 764-2 can encrypt transmissions that follow successful completion of a 4-way handshake.

Wireless circuits 738 can provide wireless communications compatible with one or more wireless standards. Wireless circuits 738 can include MAC layer circuits 738-0, physical layer (PHY) circuits 738-1, and RF circuits 738-2. In some embodiments, such circuits can be compatible with one or more IEEE 802.11 standards, on any suitable band, including but not limited to the 2.4 GHZ, 5 GHZ and/or 6 GHz bands.

IO circuits 740 can input or output signals that can enable control of a wireless device 732 from external sources according to any suitable fashion as described herein and equivalents. Bridge interface circuits 786 can enable communication between wireless circuits 738 and other wireless circuits 766. In some embodiments, such communications can establish which wireless circuits (738 or 766) can control a shared medium (e.g., 2.4 GHz band), or otherwise mitigate sharing of a same band.

Other wireless circuits 766 can be one or more wireless circuits compatible with a standard other than an IEEE 802.11 wireless standard. Such other standards can include but are not limited to, one or more Bluetooth standards, one or more IEEE 802.15.4 or related standards and/or one or more cellular network standards.

A wireless device 732 can operate in conjunction with an antenna system 750 having one or more antennas compatible with one or more IEEE 802.11 wireless standards, as well as other standards if another wireless section 766 is included.

In some embodiments, IO circuits 740, controller circuits 734, and wireless circuits 738 can be formed with a same integrated circuit substrate 752. In some embodiments, memory circuits 736 can also be formed with a same substrate 752 as the other circuits (e.g., 764, 738, 740).

In this way, a wireless device compatible with one or more IEEE 802.11 wireless standards can serve as a Supplicant in an authentication hierarchy, and generate a nonce for transmission in a 4-way handshake that is used to derive a temporal encryption key. Such a nonce can include a secret code identifying additional capabilities of the wireless device.

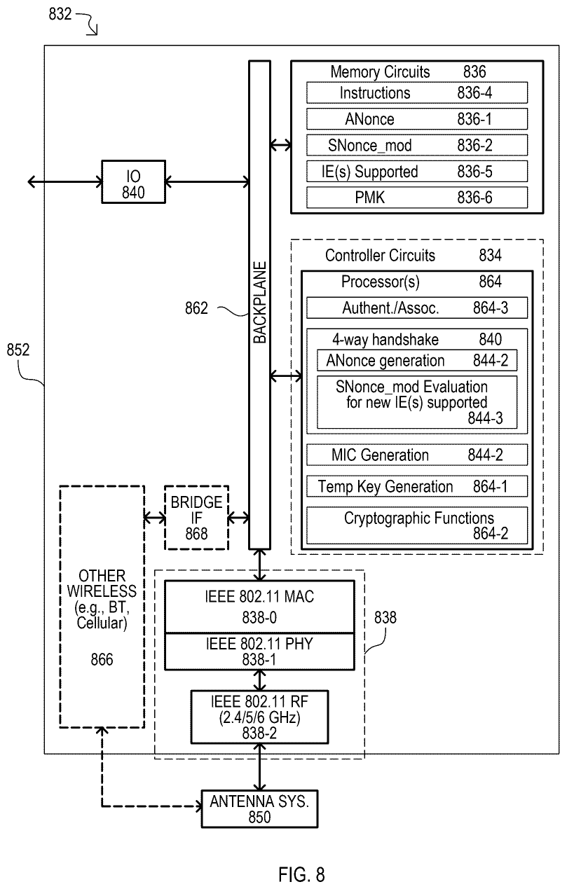

FIG. 8 is a block diagram of a wireless device 832 according to another embodiment. In some embodiments, a wireless device 832 can be one implementation of that shown in FIG. 6, including an Authenticator as described for embodiments herein. A wireless device 832 can include items like those of FIG. 7, and such like items are referred to by the same reference character but with the leading digit being a “8” instead of “7”.

A wireless device 832 can differ from that of FIG. 7 in that memory circuits 836 can include instructions 836-4 for executing operations of controller circuits 834 (that can be different from those of FIG. 7). In addition, wireless device 832 can include a set of different IE(s) that it supports 836-5, which can be greater than those supported by a single Supplicant device (i.e., wireless device 832 can support IEs of different vendors).

Controller circuits 864 can differ from that of FIG. 7 in that authentication/association operations 864-3 can occur with wireless device 832 operating as an Authenticator.

4-way handshake operations 840 can include generation of ANonce 854-0. Such an operation 854-2 can generate an Authenticator nonce according to a predetermined protocol, and transmit it to a Supplicant. Operations 844-3 can include evaluating a received SNonce_mod to determine new IE(s) supported by a sending device. Such operations can include any of those described herein and equivalents.

In this way, a wireless device compatible with one or more IEEE 802.11 wireless standards can serve as an Authenticator in an authentication hierarchy, and receive a nonce in a 4-way handshake. A portion of such a received nonce can include a secret code that when decoded, can identify additional capabilities of the wireless device sending the nonce.

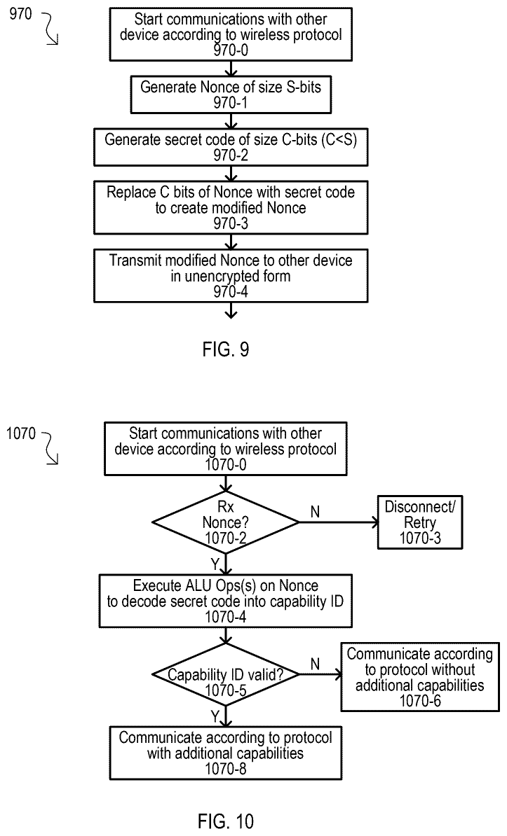

FIG. 9 is a flow diagram of a method 970 according to an embodiment. In some embodiments, a method 970 can be executed by circuits of a second wireless device or Supplicant, as described herein and equivalents. A method 970 can include starting communications with another device according to a protocol 970-0. Such an action can include any suitable exchange of transmissions, including received messages and/or combinations of received and transmitted messages. A nonce of size S-bits can be generated 970-1. Such an action can include the generation of a nonce or nonce-like value as described herein and equivalents.

A method 970 can generate a secret code of size C-bits, where C smaller than S 970-2. A secret code can take the form of any of those described herein and equivalents. In some embodiments, when decoded, a secret code can convey capabilities of a device. C bits of a generated nonce can be replaced with bits of the secret code to create a modified nonce 907-3. Such a replacement can include replacing a consecutive range of bits. However, other embodiments can include bits of a secret code residing in non-contiguous sections of the corresponding nonce.

A modified nonce can be transmitted to another device in unencrypted form 970-4. Such an action can include transmitting a frame according to a protocol with one or more predetermined fields including a modified nonce in unencrypted form.

In this way, a device can generate a multi-bit nonce, substitute selected bits of the nonce with a secret code that identifies device capabilities, and transmit such a value, unencrypted, to another device.

FIG. 10 is a flow diagram of a method 1070 according to another embodiment. In some embodiments, a method 1070 can be executed by circuits of a first wireless device or Authenticator, as described herein and equivalents. A method 1070 can include starting communications with another device according to a protocol 1070-0. Such an action can include transmissions as described herein or equivalents. According to such a protocol, a nonce can be expected from another device.

A method 1070 can include determining if a nonce has been received 1070-2. Such an action can include processing a received wireless message in any suitable fashion, including but not limited to determining if a predetermined field is included in a received frame, and storing a value included in the frame. If a nonce is not received (N from 1070-2), there can be a retry in communications and/or communications can end (i.e., disconnection) 1070-3.

If a nonce is received (Y from 1070-2), a method 1070 can execute one or more ALU Ops on a nonce to decode a secret code therein to reveal a capability ID 1070-4. A capability ID can be checked for validity 1070-5. Such an action can include determining if a capability ID matches a list of existing capability IDs. If a capability ID is not considered valid (N from 1070-5), a method 1070 can communicate according to a protocol without additional capabilities 1070-6. If a capability ID is considered valid (Y from 1070-5), a method 1070 can communicate according to a protocol with additional capabilities indicated by a capability ID.

In this way, a device can receive a nonce, execute arithmetic and/or logic operations on such a nonce to decode a secret code. If a secret code is successfully decoded, subsequent wireless communications can include additional capabilities indicated by the secret code.

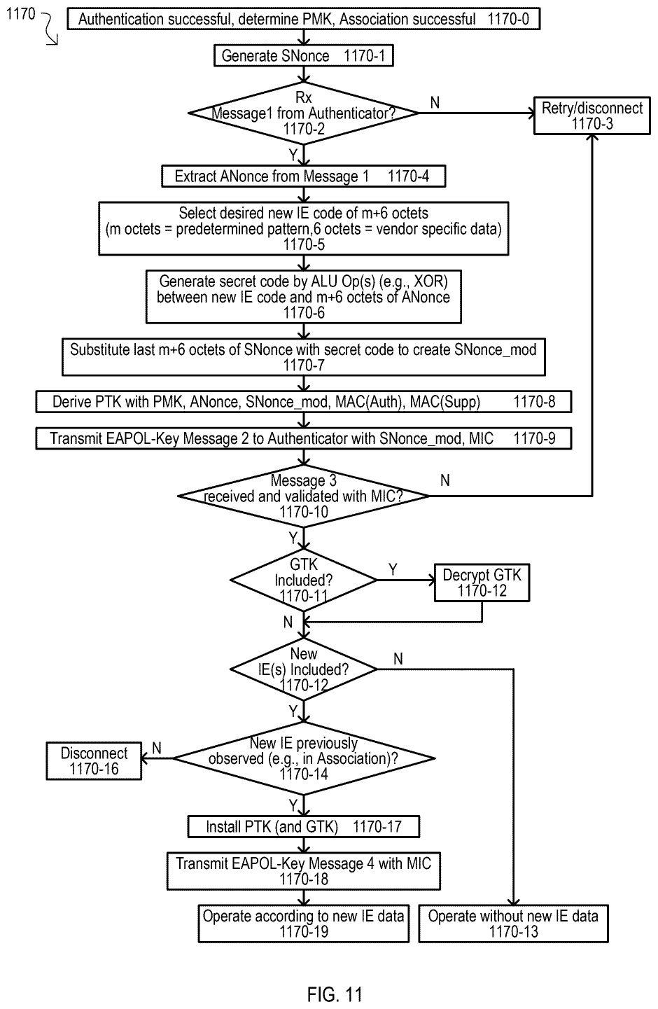

FIG. 11 is a flow diagram of a method 1170 according to another embodiment. In an embodiment, a method 1170 can be executed by a Supplicant that performs a 4-way handshake with an Authenticator. In some embodiments, a method 1170 can be executed by a station device (STA), compatible with one or more IEEE 802.11 wireless standards, seeking to join a wireless service by communicating with an access point device (AP). A method 1170 can start with a successful authentication operation, which can include the determination of a PMK, as well as a successful association operation 1170-0.

After successful authentication and association, a method 1170 can generate an initial nonce, SNonce 1170-1. Such an action can include any of those described herein, or equivalents. According to a protocol, a method 1170 can await receipt of a Message1. If a Message1 is not received (N from 1170-2), an attempt to connect can be retried and/or communication can end with disconnection 1170-3. In some embodiments, retries and disconnection can be based on repeated attempts, timeout limits or combinations thereof. If a Message1 is received (Y from 1170-2), an ANonce can be extracted from Message1 1170-4. In some embodiments, such an action can include copying data from a predetermined frame field of Message1 and storing it in memory circuits. In some embodiments, ANonce can be a 32 octet value.

A method 1170 can determine a new IE code of m+6 octets 1170-5. Such an action can include determining additional capabilities of a device. In some embodiments, such additional capabilities can be particular to manufacturers, and can be indicated by, or can utilize data in new IEs transmitted between devices. As noted herein, it is understood that new IEs include data to enable capabilities in addition to functions provided by a base protocol or standard. Such additional capabilities can be part of a protocol or standard, but are not automatically supported, but can be supported if indicated by a new IE code, or equivalent data value. In some embodiments, m octets of a code can be a predetermined pattern (i.e., predetermined bit values) that can help establish a validity of the new IE code. Six octets of the new IE code can be vendor specific data which can identify additional capabilities.

A secret code can be generated by one or more ALU Ops between the new IE code and a corresponding number of bits (i.e., m+6 octets) of the received ANonce 1170-6. In one embodiment, an ALU Op can include a logical XOR for rapid resolution (i.e., decoding) of a new IE code by a receiving device (i.e., Supplicant). However this should not be construed as limiting. Alternate embodiments anticipate more complex operations, including but not limited to encryption of a new IE code using a mutually established encryption key and/or public key infrastructure. In an embodiment, a secret code can have a same bit length as the corresponding new IE code (e.g., m+6 octets). Having generated a secret code, a modified SNonce (SNonce_mod) can be generated by substituting a last m+6 octets of the initial SNonce with the secret code 1170-7. In keeping with a 4-way handshake protocol, a method 1170 can include deriving a PTK using the previously determined PMK, ANonce and SNonce_mod, a Supplicant MAC address and an Authenticator MAC address 1170-8. However, in contrast to conventional approaches, a key is generated using SNonce_mod and not the initial SNonce.

A method 1170 can transmit a Message2 to another wireless device (e.g., Authenticator) that includes SNonce_mod and a MIC 1170-9. In the embodiment shown, such a message can include an EAPOL key frame.

According to a protocol, a method 1170 can await receipt of a Message3. If a Message3 is not received or its MIC not validated (N from 1170-10), an attempt to connect can be retried and/or communication can end with disconnection 1170-3. If a Message3 is received and validated with its corresponding MIC (Y from 1170-10), such a message can be examined for the inclusion of a GTK 1170-11. If a GTK is indicated, it is assumed to have been encrypted and so can be decrypted 1170-12. In some embodiments, a GTK can be decrypted using the derived PTK.

Message3 can also be examined for the inclusion of one or more new IE(s) 1170-12. Such an action can include determining if appropriate fields have been included in Message3. If new IE(s) are not included in Message3 (N from 1170-12), it can indicate additional capabilities are not supported, and operations can continue without new IE data 1170-13.

If new IE(s) are included in Message3 (Y from 1170-12), such new IE(s) can be compared to new IEs previously observed 1170-14. In some embodiments, new IEs can have been previously observed in a message from another device (e.g., Authenticator), such as in a beacon and/or probe response received during an authentication/association operation. If a previously observed new IE is not an IE included in Message3 (N from 1170-14), disconnection can occur 1170-16. This can defeat man-in-the-middle type attacks that may insert or change IEs included in a false Message3.

If a previously observed new IE is included in Message3 (Y from 1170-14), a PTK, and if included GTK, can be installed 1170-17. Such an action can include establishing PTK for communications with a corresponding device (e.g., Authenticator) and GTK for multi-cast and/or broadcast transmissions. A Message4 can be transmitted with a MIC 1170-18. Such a Message4 can convey state data of a device, including successful installation of the PTK (and GTK). Operations can then continue that can utilize new IE data 1170-19.

In this way, a method can execute a 4-way handshake in which (1) a first nonce is received in a Message1; (2) a secret code is generated with ANonce and new IE data and included in a second nonce transmitted in a Message2; and (3) a received Message3 can be examined for new IE(s) indicated by the new IE data. If valid new IEs are detected, communications can continue with capabilities indicated by the new IEs.

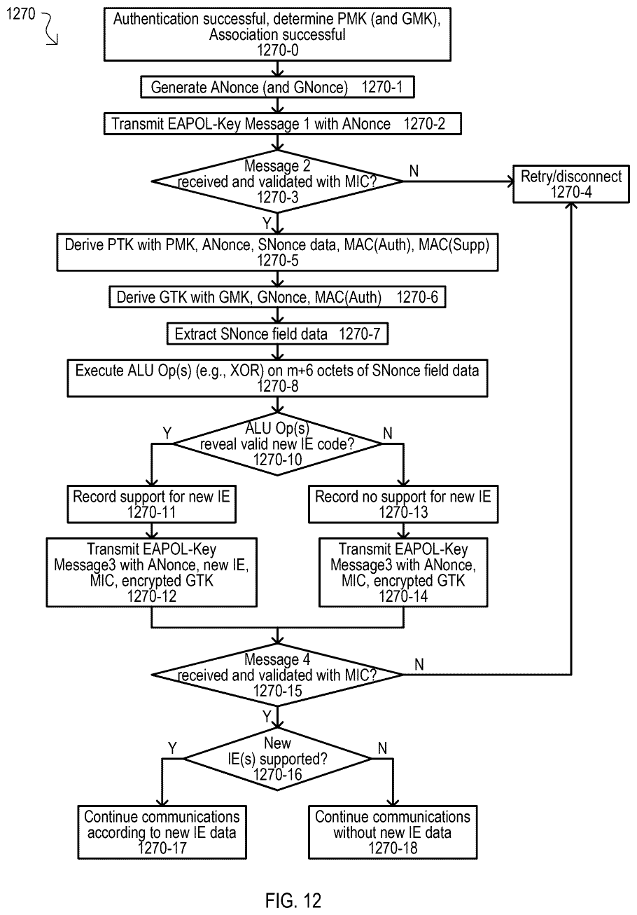

FIG. 12 is a flow diagram of a method 1270 according to another embodiment. In an embodiment, a method 1270 can be executed by an Authenticator that performs a 4-way handshake. In some embodiments, a method 1270 can be executed by an AP compatible with one or more IEEE 802.11 wireless standards, communicating with a STA seeking to join its wireless service. A method 1270 can start with a successful authentication operation, which can include the determination of a PMK, a group master key (GMK), as well as a successful association operation 1270-0.

After successful authentication and association, a method 1270 can generate an ANonce (and optionally a GNonce) 1270-1. Such an action can include any of those described herein, or equivalents. In an embodiment, an ANonce can be a 32-octet value. A Message1 can be transmitted that includes ANonce 1270-2. In some embodiments, ANonce can be transmitted in Message1 unencrypted. A GNonce can be a nonce used in deriving a group encryption key. In the embodiment shown, Message1 can be an EAPOL key message.

According to a protocol, a method 1270 can await receipt of a Message2. If a Message2 is not received (N from 1270-3), an attempt to connect can be retried and/or communication can end with disconnection 1270-4. If a Message3 is received (Y from 1270-3), a method 1270 can include deriving a PTK using the previously determined PMK, ANonce and SNonce data received in Message2, a Supplicant MAC address and an Authenticator MAC address 1270-5. A GTK can be derived using a GMK, GNonce and Authenticator MAC address 1270-6.

Field data for a SNonce can be extracted 1270-8. In some embodiments, such an action can include copying data from a predetermined frame field of Message3 and storing it in memory circuits. In some embodiments, such SNonce data can be a 32 octet value. A method 1270 can execute one or more ALU Ops on m+6 octets of SNonce field data 1270-8. In some embodiments, such an operation can also include a portion (e.g., m+6 octets) of ANonce. In an embodiment, an ALU Op can include a logical XOR between portions of SNonce data and portions of ANonce. However, that should not be construed as limiting.

Results of ALU Ops can be checked for a valid IE code 1270-10. Such an action can include determining if resulting bit values match any of a number of sets of valid IE codes stored in memory circuits. In some embodiments, such an action can include determining that resulting bit values include a predetermined matching value.

If ALU Ops reveal a valid new IE code (Y from 1270-10), a method can record that one or more new IE(s) are supported by the connection 1270-11. A Message3 can be transmitted that includes ANonce, any new IE(s) indicated by a valid new IE code, a MIC and an encrypted GTK 1270-12. In some embodiments, a Message3 can be an EAPOL key frame. If ALU Ops do not reveal a valid new IE code (N from 1270-10), a method can record that new IE(s) are not supported by the connection 1270-13. A Message3 can be transmitted like that of 1270-12, but without any new IEs 1270-14.

According to a protocol, a method 1270 can await receipt of a Message4. If a Message4 is not received (N from 1270-15), an attempt to connect can be retried and/or communication can end with disconnection 1270-4. If a Message4 is received and validated with its corresponding MIC (Y from 1270-15) and new IE(s) are supported (Y from 1270-16), a method can continue communications according to new IE data 1270-17. If a Message4 is received and validated (Y from 1270-15) and new IE(s) are not supported (N from 1270-16), a method can continue communications without new IE data 1270-18.

In this way, a method can execute a 4-way handshake in which (1) a first nonce is transmitted in a Message1; (2) portions of Message2 can be subject to one or more arithmetic and/or logic operations to determine if new IEs are supported; and (3) a Message3 can be transmitted with new IEs, if such new IEs are supported.

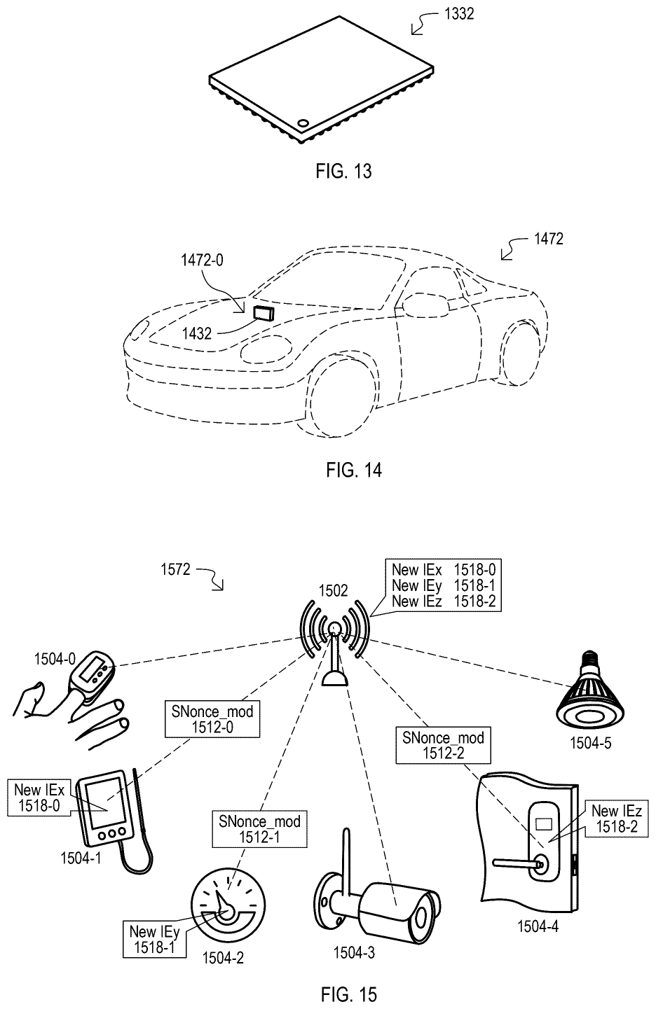

While embodiments can include wireless devices with various interconnected components, embodiments can also include unitary wireless devices which can utilize nonce values that carry a secret code as described herein and equivalents. In some embodiments, such unitary devices can be advantageously compact single integrated circuit (IC). FIG. 13 shows a packaged IC device 1332 that can execute 4-way handshake operations as a Supplicant or Authenticator. In some embodiments, IC device 1332 can include circuits and/or a substrate as shown in any of FIGS. 5 to 8. While FIG. 13 shows a particular package, alternate embodiments can include any other suitable integrated circuit packaging type, as well as direct bonding of a device chip onto a circuit board or substrate.

In this way, a wireless device as described herein can take the form of an integrated circuit device.

While wireless device embodiments can include integrated circuit devices, other embodiments can take other forms, such as smartphones or other portable computing devices, including but not limited to tablet computing devices, laptop computers, or wearable computing devices.

Embodiments can enjoy application in any wireless systems where a protocol transmits a nonce value, and provides a baseline service or capability that can be added to, or otherwise supplemented by the communication of additional capability data (e.g., new IEs). FIGS. 14 and 15 show but a few examples of many possible systems according to embodiments.

FIG. 14 shows a motor vehicle system 1472 according to an embodiment. A motor vehicle system 1472 can include one or more subsystems 1472-0 (e.g., in-vehicle infotainment system). A subsystem 1472-0 can include a wireless device 1432 in the form of any of those described herein, or equivalents.

In this way, vehicles can include wireless systems that can request and/or provide additional capabilities based on a secret code transmitted or received in a nonce.

FIG. 15 shows a system 1572 according to a further embodiment. System 1572 can include a controller wireless device 1502 and a number of other wireless devices 1504-0 to 1504-5. A controller device 1502 can enable other wireless devices to be added to a wireless network (e.g., an AP). Controller device 1502 can be capable of communicating according to a baseline set of features, as well as additional features that can include new IEs. In the embodiment shown, controller device 1502 can support a number of new IEs 1518-0, 1518-1, 1518-2.

In the embodiment shown, other wireless devices (1504-0 to 1504-5) can be “Internet-of-things” (IoT) type devices, including but not limited to: medical devices 1504-0/1, instrumentation devices 1504-2, security devices 1504-3/4, or lighting devices 1504-5. However, such wireless devices are provided by way of example, and any suitable wireless device can benefit from the advantageous operations described herein and equivalents. Other wireless devices (1504-0 to 5) can be capable of connecting to a network through communications with controller device 1502 according to one or more protocols, to enable a baseline set of operations or capabilities. However, wireless devices 1504-1, 1504-2 and 1504-4 can provide additional capabilities beyond such a baseline set that can utilize new IEs.

Accordingly, in communications with controller device 1502, other wireless device 1504-1 can include a SNonce_mod value 1512-0, that can be a nonce modified to include a secret code identifying new IE 1518-0. Upon receiving SNonce_mod 1512-0, controller device 1502 can decode the secret code, and then continue operations using new IEx 1518-0, which can be identified by SNonce_mod 1512-0. In some embodiments, SNonce_mod 1512-0 can be transmitted during a 4-way handshake operation. Similar operations can occur for other wireless devices 1504-2 and 1504-4, with such devices transmitting SNonce_mod 1512-1 and 1512-2 to convey support for new IEy 1518-1 and new IEz 1518-2, respectively.

In some embodiments, a controller device 1502 can be a AP and other wireless devices 1504-0 to 1504-5 can be STAs in a basic service set compatible with one or more IEEE 802.11 wireless standards.

In this way, a wireless network controller device (e.g., AP), can evaluate received nonces from other wireless devices, to determine if such devices support additional capabilities (new IEs).

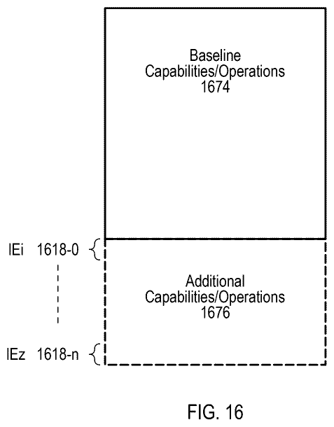

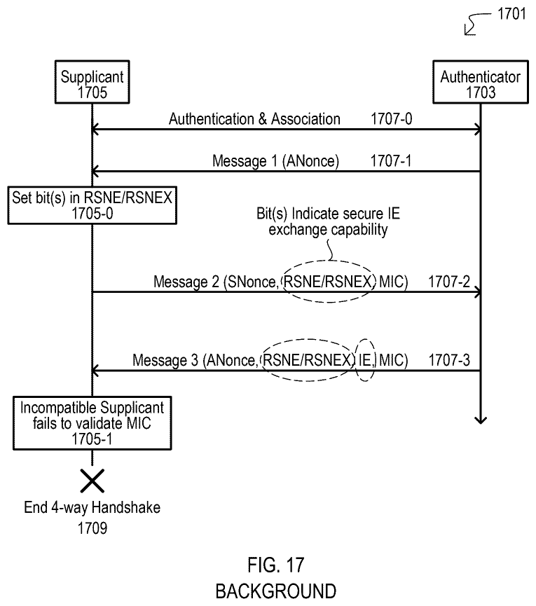

FIG. 16 is a diagram showing capabilities of wireless devices that can be included in embodiments. Wireless devices can operate according to baseline capabilities 1674. However, additional IEs can enable additional capabilities/operations 1676. In some embodiments, such capabilities/operations can use and/or correspond to new IEs 1618-0 to 1618-n. Some wireless devices can support all such additional capabilities, a subset of such additional capabilities, or but one such additional capability. By transmission of a modified nonce that includes a secret code, that a receiver is capable of decoding, a wireless device can convey its additional capabilities. Additional capabilities can include, but are not limited to, security features, and new IEs can include data identifying or related to such security features.

In this way, additional capabilities of a wireless device, determined by IEs, can be signaled by a secret code in a nonce.

Embodiments can include methods, devices and systems that include, by operation of a first wireless device, generating an internal nonce value having S-bits, generating a code of C-bits by executing at least a first arithmetic-logic (ALU) operation on at least a capability identification value (ID), where C<S, substituting C-bits of the internal nonce value with the code to create a modified nonce value, and wirelessly transmitting the modified nonce in a modified nonce message addressed to a second wireless device. In response to a received wireless response message not including capability data corresponding to the code, a method can include executing wireless operations according to a first set of capabilities and, in response to the wireless response message including capability data, executing wireless operations with capabilities in addition to those of the first set.

Embodiments can include methods, devices and systems having controller circuits comprising arithmetic-logic circuits configured to generate an internal nonce of S-bits, generate a code of C-bits by executing at least a first arithmetic-logic (ALU) operation on at least a capability identification value (ID) and substituting C-bits of the initial nonce value with the code to create a modified nonce, where C<S, execute wireless operations according to a first set of capabilities in response to a response wireless message not including additional capability data corresponding to the code, and executing wireless operations with capabilities in addition to the first set in response to the response wireless including capability data. Wireless circuits that operate according to at least one wireless standard and are configured to transmit at least a wireless modified nonce message addressed to a second wireless device that includes the modified nonce, and receive at least the response wireless message.

Embodiments can include methods, devices and systems having a first wireless device configured to generate an internal nonce value having S-bits, generate a code of C-bits by executing at least a first arithmetic-logic (ALU) operation on at least a capability identification value (ID), where C<S, substitute C-bits of the internal nonce value with the code to create a modified nonce value, wirelessly transmit the modified nonce in a modified nonce message addressed to a second wireless device. In response to a wireless response message not including capability data corresponding to the code, a system can execute wireless operations according to a first set of capabilities. In response to the wireless response message including capability data, a system can execute wireless operations with capabilities in addition to those of the first set.

Methods, devices and systems according to embodiments can include a modified nonce transmitted in unencrypted form.

Methods, devices and systems according to embodiments can include a code comprising a first portion configured to provide a matching value for verifying the code, and a second portion configured to provide the capability ID.

Methods, devices and systems according to embodiments can include, by operation of the first wireless device, prior to generating the code, receiving an external nonce in a wireless first nonce message, and a first ALU operation can include using at least a portion of the external nonce.

Methods, devices and systems according to embodiments can include a modified nonce message being a second message according to four-way handshake protocol; and a wireless response message being a third message in the four-way handshake protocol.

Methods, devices and systems according to embodiments can include a four-way handshake protocol that is compatible with at least one IEEE 802.11 wireless standard.

Methods, devices and systems according to embodiments can include, by operation of the second wireless device, executing at least a second ALU operation on at least a portion of the modified nonce to generate at least the capability ID, determining the capability data from the capability ID, and transmitting the wireless response message.

Methods, devices and systems according to embodiments can include, by operation of the second wireless device, generating a second nonce and transmitting the second nonce in a first nonce message to the first wireless device. By operation of a first wireless device, a code can be generated with at least a first ALU operation and at least a portion of the second nonce.

Methods, devices and systems according to embodiments can include, by operation of the first wireless device, executing an authentication protocol with the second wireless device to derive a first encryption key, receiving an external nonce in a wireless first nonce message from the second wireless device, and deriving a second encryption key with at least the first encryption key, the modified nonce and the external nonce.

Methods, devices and systems according to embodiments can include wireless circuits configured to transmit a modified nonce in unencrypted form.

Methods, devices and systems according to embodiments can include wireless circuits configured to receive a wireless first nonce message from the second wireless device that includes an external nonce, and at least a first ALU operation executed on at least a portion of the external nonce.

Methods, devices and systems according to embodiments can include operating according to at least one IEEE 802.11 wireless standard that includes a four-way handshake. A wireless modified nonce message can be a second message according to the four-way handshake. A response message can be a third message according to the four-way handshake.

Methods, devices and systems according to embodiments can have a first wireless device configured to receive a wireless first nonce message that includes an external nonce; and the at least first ALU operation is executed on at least a portion of the external nonce.

Methods, devices and systems according to embodiments can include a first wireless configured to derive a first encryption key in an authentication operation, and derive a second encryption key with at least the first encryption key, the external nonce, and the modified nonce.

Methods, devices and systems according to embodiments can include second wireless device configured to generate a second nonce, wirelessly transmit the second nonce to the first wireless device in a first nonce message, receive the modified nonce message, execute at least a second ALU operation at least C-bits of the modified nonce to determine at least the capability ID, and transmit the response message.

Methods, devices and systems according to embodiments can include a first wireless device configured to, following receipt of the response message, transmit a confirmation message to the second wireless device. A first nonce message can be a first message in a four-way handshake protocol. A modified nonce message can be a second message in a four-way handshake protocol. A response message can be a third message in a four-way handshake protocol. A confirmation message can be a fourth message in the four-way handshake protocol. The four-way handshake protocol can be compatible with at least one IEEE 802.11 wireless standard.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A method, comprising:
by operation of a first wireless device,
generating an internal nonce value having S-bits,
generating a code of C-bits by executing at least a first arithmetic-logic (ALU) operation on at least a capability identification value (ID), where C<S,
substituting C-bits of the internal nonce value with the code to create a modified nonce value,
wirelessly transmitting the modified nonce in a modified nonce message addressed to a second wireless device,
in response to a received wireless response message not including capability data corresponding to the code, executing wireless operations according to a first set of capabilities, and
in response to the wireless response message including capability data, executing wireless operations with capabilities in addition to those of the first set.

2. The method of claim 1, wherein:
the modified nonce is transmitted in unencrypted form.

3. The method of claim 1, wherein:
the code comprises
a first portion configured to provide a matching value for verifying the code, and
a second portion configured to provide the capability ID.

4. The method of claim 1, further including:
by operation of the first wireless device,
prior to generating the code, receiving an external nonce in a wireless first nonce message, and
the at least first ALU operation includes using at least a portion of the external nonce.

5. The method of claim 1, wherein:
the modified nonce message is a second message according to four-way handshake protocol; and
that wireless response message is a third message in the four-way handshake protocol.

6. The method of claim 5, wherein:
the four-way handshake protocol is compatible with at least one IEEE 802.11 wireless standard.

7. The method of claim 1, further including:
by operation of the second wireless device,
executing at least a second ALU operation on at least a portion of the modified nonce to generate at least the capability ID,
determining the capability data from the capability ID, and
transmitting the wireless response message.

8. The method of claim 1, further including:
by operation of the second wireless device,
generating a second nonce, and
transmitting the second nonce in a first nonce message to the first wireless device; and
by operation of the first wireless device, generating the code with the at least first ALU operation and at least a portion of the second nonce.

9. The method of claim 1, further including:
by operation of the first wireless device,
executing an authentication protocol with the second wireless device to derive a first encryption key,
receiving an external nonce in a wireless first nonce message from the second wireless device, and
deriving a second encryption key with at least the first encryption key, the modified nonce and the external nonce.

10. A device, comprising:
controller circuits comprising arithmetic-logic circuits configured to
generate an internal nonce of S-bits,
generate a code of C-bits by executing at least a first arithmetic-logic (ALU) operation on at least a capability identification value (ID) and substituting C-bits of the initial nonce value with the code to create a modified nonce, where C<S,
execute wireless operations according to a first set of capabilities in response to a response wireless message not including additional capability data corresponding to the code, and executing wireless operations with capabilities in addition to the first set in response to the response wireless including capability data; and
wireless circuits that operate according to at least one wireless standard and are configured to
transmit at least a wireless modified nonce message addressed to a second wireless device that includes the modified nonce, and
receive at least the response wireless message.

11. The device of claim 10, wherein:
the wireless circuits are configured to transmit the modified nonce in unencrypted form.

12. The device of claim 10, wherein:
the code comprises
a first portion configured to provide a matching value for verifying the code, and
a second portion configured to provide the capability ID.

13. The device of claim 10, wherein:
the wireless circuits are configured to receive a wireless first nonce message from the second wireless device that includes an external nonce; and
the at least first ALU operation is executed on at least a portion of the external nonce.

14. The device of claim 9, wherein:
the at least one wireless standard is an IEEE 802.11 wireless standard that includes a four-way handshake;
the wireless modified nonce message is a second message according to the four-way handshake; and
the response message is a third message according to the four-way handshake.

15. A system, comprising:
a first wireless device configured to
generate an internal nonce value having S-bits,
generate a code of C-bits by executing at least a first arithmetic-logic (ALU) operation on at least a capability identification value (ID), where C<S,
substitute C-bits of the internal nonce value with the code to create a modified nonce value,
wirelessly transmit the modified nonce in a modified nonce message addressed to a second wireless device,
in response to a wireless response message not including capability data corresponding to the code, executing wireless operations according to a first set of capabilities, and
in response to the wireless response message including capability data, executing wireless operations with capabilities in addition to those of the first set.

16. The system of claim 15, wherein:
the first wireless device is further configured to
receive a wireless first nonce message that includes an external nonce; and
the at least first ALU operation is executed on at least a portion of the external nonce.

17. The system of claim 16, wherein:
the first wireless is further configured to
derive a first encryption key in an authentication operation, and
derive a second encryption key with at least the first encryption key, the external nonce, and the modified nonce.

18. The system of claim 15, wherein:
the code comprises
a first portion configured to provide a matching value for verifying the code, and
a second portion configured to provide the capability ID.

19. The system of claim 15, further including:
a second wireless device configured to
generate a second nonce,
wirelessly transmit the second nonce to the first wireless device in a first nonce message,
receive the modified nonce message,
execute at least a second ALU operation at least C-bits of the modified nonce to determine at least the capability ID, and
transmit the response message.

20. The system of claim 19, wherein:
the first wireless device is further configured to, following receipt of the response message, transmit a confirmation message to the second wireless device;
the first nonce message is the first message in a four-way handshake protocol;
the modified nonce message is the second message in the four-way handshake protocol;
the response message is the third message in the four-way handshake protocol;
the confirmation message is the fourth message in the four-way handshake protocol; and
the four-way handshake protocol is compatible with at least one IEEE 802.11 wireless standard.
